(19) United States
(12) Patent Application Publication
(10) Pub. No.: US 2002/0116637 A1
(43) Pub. Date: Aug. 22, 2002

(54) Gateway for securely connecting arbitrary devices and service providers

(75) Inventors: Andrew Issac Deitsch, Clifton Park, NY (US); Marc Anthony Garbiras, Albany, NY (US); William Phillip Gorman, Niskayuna, NY (US); Jonathan Michael Houlihan, Schenectady, NY (US); Daniel Lawrence Morrill, Clifton Park, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/741,251

(22) Filed: Dec. 21, 2000

(51) Int. Cl. G06F 11/30

(52) U.S. Cl. 713/201

(57) ABSTRACT

A gateway for securely connecting arbitrary devices and service providers. A request handler receives activity requests from a device and a service provider. An authenticator and access authorizer permit the device and service provider to interact with each other. An activity manager manages the activities between the device and the service provider. A response component forwards the response to either the service provider or the device. The gateway device is suitable for use in remote monitoring and diagnostics of industrial and commercial equipment as well with the monitoring and maintenance of consumer products.

### BACKGROUND OF THE INVENTION

This disclosure relates generally to networking and more particularly to a gateway for securely connecting devices and service providers.

Currently, there is a trend towards developing devices such as consumer electronics, appliances, and industrial equipment that are network aware. Network aware devices are devices that are capable of communicating via some mechanism with other potentially unrelated devices. For example, a smoke detector that is network aware might have the capability to send a message to activate a network aware alarm clock to notify a sleeping homeowner that smoke has been detected. In addition, it is possible to have these network aware devices communicate with service providers to request, furnish, and receive information and other services. For example, a dishwasher that is network aware might have the capability to notify a service provider of problems such as an impending failure. Alternatively, the service provider might have the capability to monitor the operational status of the dishwasher, warn the homeowner of a problem or an incipient problem or even schedule a maintenance appointment.

As more devices are made network aware, problems might arise as the devices communicate with each other and service providers over networks such as the Internet or other Wide-Area Networks (WANs). One particular problem that might arise relates to the security of the devices. More specifically, as the network aware devices communicate over the Internet or other WANs, the devices could potentially be accessed by unauthorized third parties. These unauthorized third parties might then have access to confidential or private information. For example, it is conceivable that a health insurance company could obtain information on the type of food in a homeowner's network aware refrigerator and then deny coverage for health insurance or provide insurance at a higher cost because of the homeowner's diet. Alternatively, unauthorized third parties could use information obtained from the network aware device to inundate the homeowner with unwanted advertising.

Another problem that will occur as the network aware devices are connected to a network such as the Internet or other WANs is that there will be limited resources such as network addresses and bandwidth to handle the vast amount of information exchanged. Still another problem that will occur as the network aware devices are connected to the Internet or other WANs is that the administration and management of the devices becomes more complex as more devices are connected and more services are offered.

In order to avoid these problems, there is a need for an approach that mediates activities between the devices and the service providers in a secure manner, without adding to the complexity of the administration of the devices, and that does not further exhaust resources.

### BRIEF SUMMARY OF THE INVENTION

In one embodiment of this disclosure, there is a system, method and computer readable medium that stores instructions for controlling a computer system, that securely manages activities between at least one device and at least one service provider. In this embodiment, an authenticator authenticates the identity of the at least one service provider and the at least one device. An access authorizer permits the at least one service provider to interact with the at least one device. An activity manager, responsive to the authenticator and the access authorizer, manages the activities occurring between the at least one service provider and the at least one device.

In a second embodiment of this disclosure, there is a system, method and computer readable medium that stores instructions for controlling a computer system, that securely provides services between a first site and a second site. In this embodiment, there is at least one appliance linked in a first network at the first site. A service provider is linked to the at least one appliance in a second network at the second site. A gateway device securely manages the services provided between the at least one appliance and the service provider. The gateway device comprises an authenticator that authenticates the identity of the service provider and the at least one appliance. An access authorizer permits the service provider to interact with the at least one appliance. A service manager, responsive to the authenticator and the access authorizer, manages the services provided between the service provider and the at least one appliance.

In another embodiment, there is a system, method and computer readable medium that stores instructions for controlling a computer system, that securely provides remote monitoring and diagnostics. In this embodiment, there is at least one device linked in a first network. A service provider is linked to the at least one device in a second network. A gateway device securely manages remote monitoring and diagnostic activities between the at least one device and the service provider. The gateway device comprises an authenticator that authenticates the identity of the service provider and the at least one device. An access authorizer permits the service provider to interact with the at least one device. An activity manager, responsive to the authenticator and the access authorizer, manages the remote monitoring and diagnostic activities provided between the service provider and the at least one device.

### BRIEF DESCRIPTION OF THE DRAWINGS

FIG. 1 shows a schematic of one embodiment of a gateway device that securely manages activities between at least one device and at least one service provider and that operates on a general purpose computer system;

FIG. 2 shows a schematic diagram of the gateway device that operates on the computer system shown in FIG. 1;

FIG. 3 shows a flow chart describing actions performed by the gateway device shown in FIG. 2;

FIG. 4 shows an alternative embodiment of the gateway device shown in FIG. 2;

FIG. 5 shows a flow chart describing actions performed by the gateway device shown in FIG. 4;

FIG. 6 shows a schematic of a gateway device in operation with a device located at a first site and a service provider located at a second site; and

FIG. 7 shows a schematic of a gateway device in operation with a plurality of devices located at a first site and linked together in a network with a plurality of service providers located at a second site.

### DETAILED DESCRIPTION OF THE INVENTION

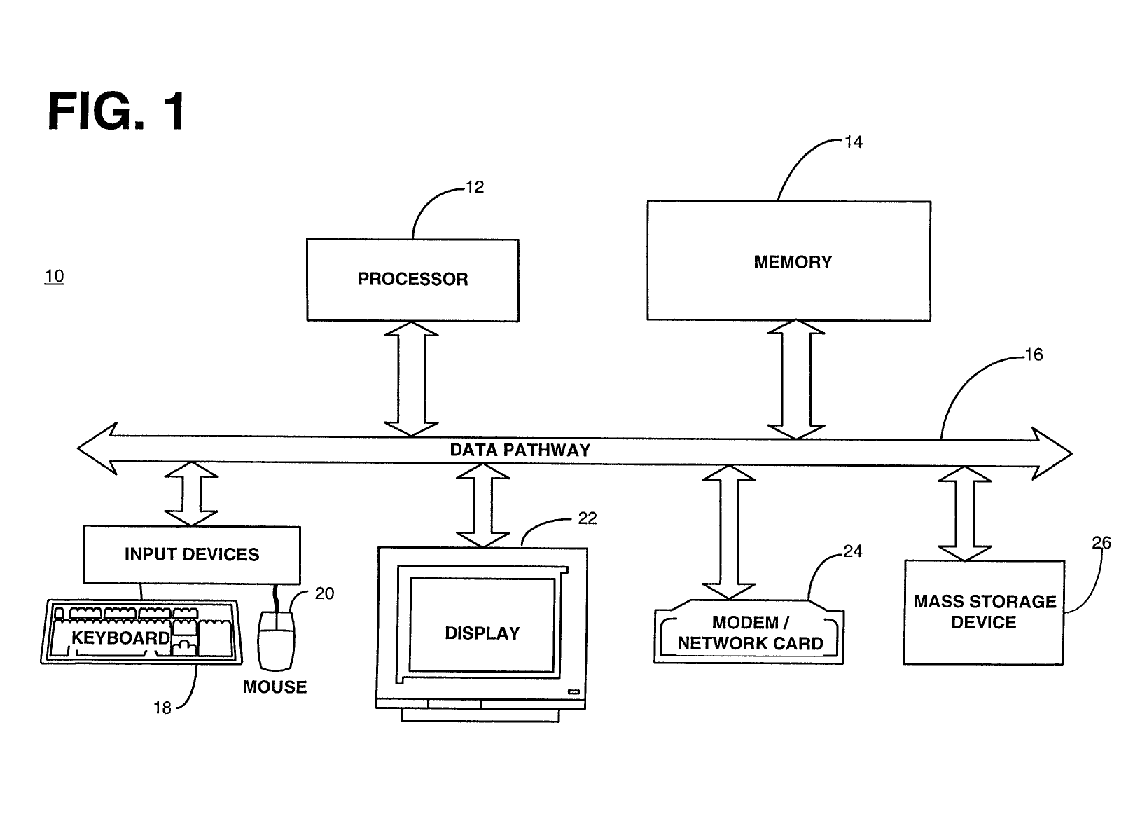

This disclosure describes a gateway for securely connecting arbitrary devices and service providers. As an example, the gateway can be implemented in software. FIG. 1 shows a schematic of a general-purpose computer system 10 in which a gateway device that securely manages activities between at least one device and at least one service provider operates. The computer system 10 generally comprises at least one processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices may comprise a keyboard 18 and a mouse 20 that enter data and instructions into the computer system 10. Also, a display 22 may be used to allow a user to see what the computer has accomplished. Other output devices could include a printer, plotter, synthesizer and speakers. A modem or network card 24 enables the computer system 10 to access other computers and resources on a network. A mass storage device 26 allows the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, personal computer, workstation, mini-computer, mainframe computer and supercomputer.

As an alternative to the embodiment shown in FIG. 1, the gateway device may be implemented in hardware such as an integrated circuit or in firmware. In these examples, there would not be a need for elements such as the keyboard 18, mouse 20, display 22 and the mass storage device 26.

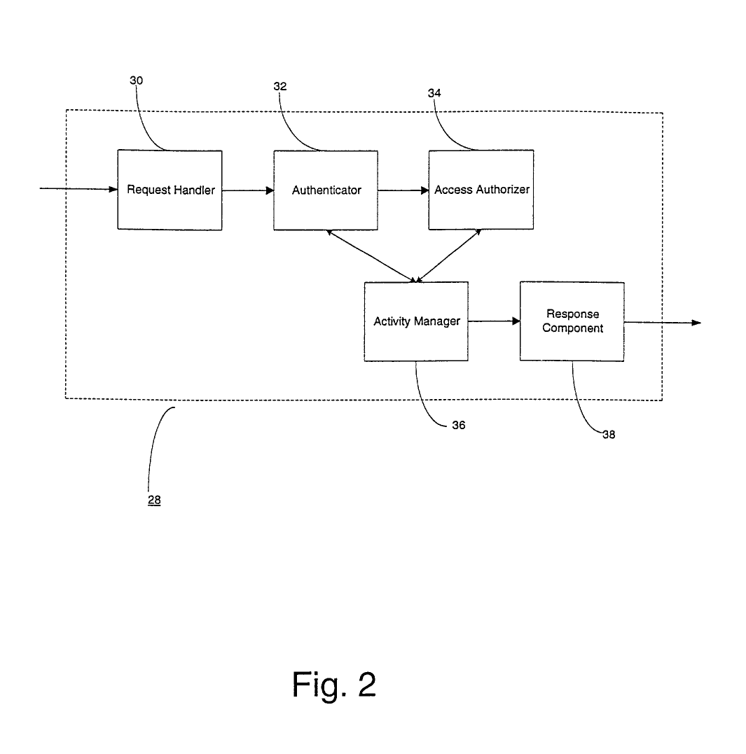

FIG. 2 shows a schematic diagram of a gateway device 28 that securely manages activities between at least one device and at least one service provider that operates on the computer system 10 shown in FIG. 1. The at least one device may be any machine, equipment or system, used in an industrial or consumer setting, where it is desirable to be network aware and/or communicate with a service provider to request, furnish and receive information and other services. Examples of a device may include consumer and electronic devices found in a home such as a refrigerator, a washing machine, an oven or industrial devices such as a medical imaging machine, a turbine, a power system, a locomotive or an aircraft engine. These examples are illustrative of only a few devices that the gateway device 28 can interact with and are not exhaustive of other possibilities. The at least one service provider may be any entity that can service the device and provide information to the device on its operation. Some activities that the gateway device 28 manages comprises communications, transactions and operations between the device and the service provider. For example, the communications, transactions and operations may comprise activities such as the transfer of information (e.g., the current cost of electricity, data and software upgrades), transfer of status information (e.g., remote monitoring and diagnostic information), upload of information (e.g., demographics) and upload of requests (e.g., deliver more groceries).

Referring to FIG. 2, in the gateway device 28 there is a request handler 30 that receives activity requests from the service provider and/or other devices. If the activity request is from a service provider, then examples of the request may comprise requests to obtain information such as status and diagnostic information and usage history. Status and diagnostic information relates to the state and operation of the device itself, while usage history relates to data on what the device has been using. Possible examples of status and diagnostic information may include information that is indicative of an impending hardware failure and information that is indicative of the level of remaining resources available to the device (e.g., the level of freon left in a consumer's freezer). Possible examples of usage history may include information that is indicative of how much resources available to the device has been used (e.g., how much food has been taken out of a refrigerator, how many hours an aircraft engine has been used, or the number of images taken by a medical scanner).

Also, the service provider may make requests such as requests to offer information to the device such as software or firmware updates, usage statistics, data updates or refreshes. Possible examples of software or firmware updates may include items such as new control software for a medical scanner, a new version of a television programming guide or schedule built into a television. Possible examples of usage statistics may include information such as the percentage of a device's maximum utilization that it is currently operating at or a usage profile that a device makes use of to alter its behavior (e.g. to conserve fuel or maximize engine life). Possible examples of data updates or refreshes could include an update to a consumer's television indicative of the upcoming week's schedule.

If the activity request is from a device, then examples of the request may comprise requests to obtain information from the service provider such as the current costs associated with receiving a particular service or requests to obtain specific data, facts, information or media. In addition, other examples of requests from the device to the provider may comprise requests to offer information to the provider such as notifications of incipient and imminent failure, usage history, status updates or periodic check-ins, etc. All of the aforementioned examples are illustrative of only a few possible requests received by the request handler 30 and are not exhaustive of other possibilities.

An authenticator 32 identifies whether the device or service provider is who they claimed to be. In an illustrative embodiment, the device or service provider making the request may have a unique identifying signature such as a digital key. The authenticator 32 comprises a digital signature verifier that verifies the signature associated with the device and service provider. Likewise, the authenticator 32 has a unique identifying signature such as a digital key that uniquely identifies the gateway device 28 to other devices and service providers.

If desired, the authenticator 32 may comprise a cryptographic component that encrypts and decrypts activities between the device and service provider. Alternatively, the authenticator 32 may be implemented with a cryptographic component that can be selectively disabled or enabled. The cryptographic component could be in the form of symmetric key cryptography, public key cryptography, or synchronized chaotic system cryptography. The cryptographic component can be used to encrypt information such as the contents of any request sent from a device to a provider, contents of any request sent from a provider to a device, any data (e.g. status data, usage history, etc.) sent as part of a request, any data sent by either side in response to a request (e.g. new TV schedule, new firmware, etc.) or any ancillary activity related to the cryptographic protocol in use (e.g. Diffie-Hellman public key negotiation or handshake). Note that the above are illustrative of only a few types of information that can be encrypted and is not exhaustive of all possibilities.

Referring to FIG. 2, an access authorizer 34 determines whether the device or service provider making the request has authorization to access the particular device. The access authorizer 34 may include an access control table, list of access control rules or logic, or other mechanisms that specifies a list of devices of which it is aware and service providers that are authorized to interact with the devices it represents. In addition, there may be a list of the types of activities that are permitted between the device and the service provider. All of this information may be exposed to the devices and service providers during any activities. Examples of possible access control tables that could be used by the access authorizer 34 are provided below in Tables 1 and 2.

TABLE 1

| Device | Service Provider | Operation | Action |
|---|---|---|---|
| Dishwasher | X | Status Check | Grant |
| Dishwasher | X | Usage History | Deny |
| Microwave | X | Any | Grant |
| Microwave | Any non-X | Any | Deny |
| X-ray scanner | Y | Firmware Update | Deny |
| X-ray scanner | Y | Any | Grant |
| Aircraft Engine | Any | Status Check | Grant |
| Any | Any | Any | Deny |

TABLE 2

| Provider | Device | Operation | Action |
|---|---|---|---|
| X | Dishwasher | Any | Grant |
| Y | Any | Any | Deny |

Tables 1 and 2 are illustrative of only a few types of access control tables that can be used and are not exhaustive of the various forms and possibilities. For example, the Device heading may be replaced by a hardware identifier or IP/network address heading, and the Service Provider heading might be replaced by a digital signature or key heading. Furthermore, the operation heading may be replaced by some other heading.

Table 1 determines which providers can do which activities to which devices. It also determines what operations provider X can perform on dishwasher. On the other hand, Table 2 determines which providers can be contacted by which devices. For example, a TV may be configured by default to check for programming from network X; however, the gateway device 28 may be configured to deny any requests sent to network X if the consumer prefers not to do business with X.

The access authorizer 34 is not limited to the use of an access control table and other authorization techniques that incorporate logic authorization may be used. Examples of possible logic authorization could be:

“Only allow Provider X to check status if battery power is less than 25%”;

“If the time is between midnight and 6am and Provider Y has already not called to check status, permit Y to check the status of the turbine”; or

“If it has been 24 hours since the last television programming guide data update, permit the TV to request an updated schedule; otherwise deny the request.”

These examples could be “hardwired” or built into the device gateway via source code or a hardware implementation, rather than expressed generally in a table format such as the above-described access control table.

An activity manager 36, responsive to the authenticator 32 and the access authorizer 34, manages the activities occurring between the device and the service provider. Initially, the activity manager 36 decrypts an incoming request if it is necessary. The activity manager 36 authenticates the identity of the requester (i.e., the device or provider) and determines whether the requester has permission to perform the activity in one of the above-described approaches. If needed, the activity manager 36 will translate the data/contents of the request into a format that is understandable by the recipient. The activity manager 36 will then translate the request into a format understandable by the network connecting the gateway to the recipient. Also, if desired, the activity manager 36 can encrypt the outgoing request and transmit it to the recipient. The functions performed by the activity manager 36 are the same regardless of whether the requester is a device and the recipient is a provider, or vice versa.

A response component 38 receives activity responses from the service provider and/or other devices and transmits the responses to the devices and service provider. The responses are generated in reply to the requests received at the request handler 30. If the activity response is from a device, then examples of the response may comprise information such as status and diagnostic information, usage history, etc. In addition, other information may comprise notifications of incipient and imminent failure, status updates or periodic check-ins. If the activity response is from a service provider, then examples of the response may comprise information such as software or firmware updates, usage statistics, data updates or refreshes. In addition, other information may comprise responses to requests regarding the current costs associated with receiving a particular service, requests for specific data, facts, information or media. These examples are illustrative of only a few possible responses generated by the response component 38 and are not exhaustive of other possibilities.

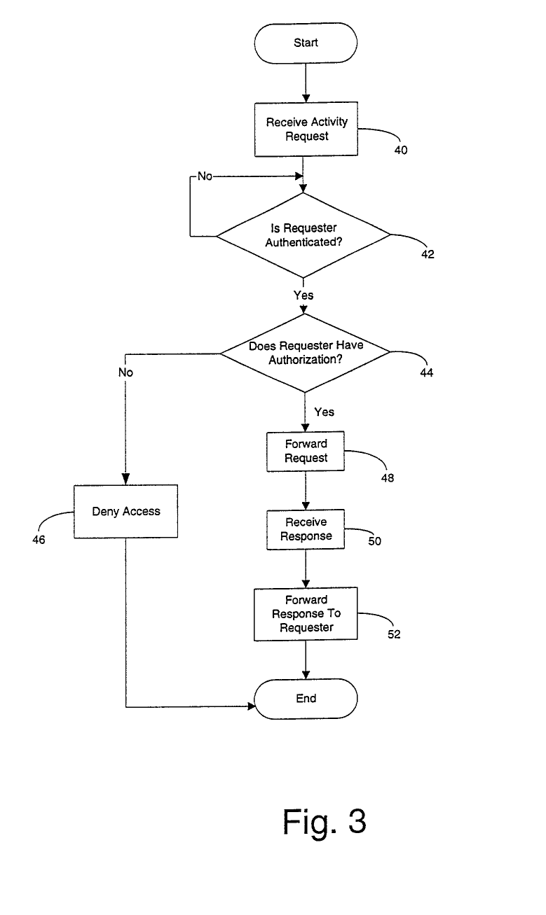

FIG. 3 shows a flow chart describing actions performed by the gateway device shown in FIG. 2. At block 40, the request handler receives an activity request from either a service provider or a device. The authenticator then identifies whether the device or service provider is who they claimed to be at 42. This comprises verifying the signature associated with the device and service provider. If there is a failure to authenticate, then the authentication is repeated until authentication occurs. The access authorizer then determines whether the device or service provider making the request has authorization to do so at 44. As mentioned above, the access authorizer determines whether the device or service provider has the requisite authorization to perform the requested activities. If there is a failure to receive authorization, then access is denied at 46. However, if the requester has authorization, then the activity manager forwards the request to the either device or service provider at 48. The response component receives the response from either the service provider or the device at 50 and forwards the response at 52.

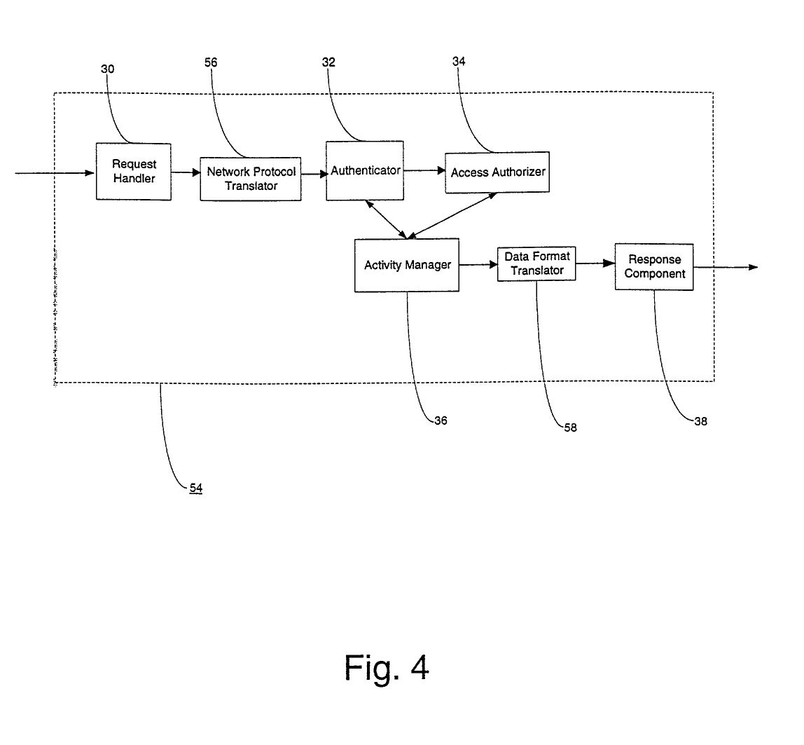

FIG. 4 shows an alternative embodiment of the gateway device shown in FIG. 2. The gateway device 54 shown in FIG. 4 is similar to the gateway device 28 shown in FIG. 2, except that a network protocol translator 56 and a data format translator 58 have been added. The network translator 56 enables a device and service provider that operates on different networks and protocols to communicate with each other. For example, the network protocol translator can translate between protocols such as TCP/IP, UDP/IP, Ethernet, IPX/SPX, Bluetooth, Jini, etc. Therefore, the network protocol translator 56 has utility if a local network connecting a plurality of devices is, for example, IPX, and the network connecting the gateway device 54 to the service provider(s) is TCP/IP. The network protocol translator also has utility in instances where the gateway device has multiple connections to multiple networks. For example, the gateway device may connect a network of devices to Service Provider A through WAN A and it may connect to Service Provider B through WAN B. In this example, the network protocol translator will translate between the various protocols used by WAN A and WAN B.

The data format translator 58 enables a device and a service provider to exchange data that are in different formats such as HITP, WAP, XML, EDI, proprietary binary format, etc. so that the data is in a usable format for the receiving party. The data format translator 58 converts between different formats by well known software or hardware that re-expresses the same content in a new format when given content in an original format. The actual meaning of the data is left unchanged. For example, an original message may receive data in XML format according to an original XML Document Type Definition, and may re-express or translate the content into a different DTD, or even into a non-XML format entirely. Another example may be translating XML data into the name/value format required by a service provider that accepts requests via the HTTP protocol. In each of these examples, the entity (hardware or software) doing the translation is unaware of the meaning of the data being translated; the translator is merely re-expressing the data's representation format.

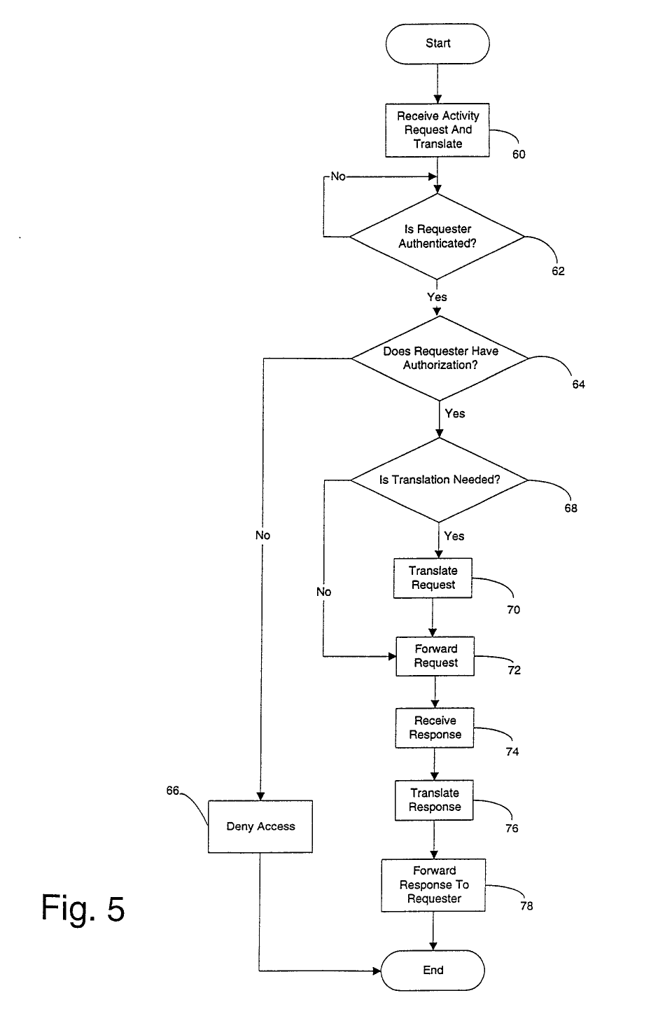

FIG. 5 shows a flow chart describing actions performed by the gateway device shown in FIG. 4. This flow chart is similar to the one shown in FIG. 3, except that the flow chart in FIG. 5 shows the network protocol translation and the data format translation.

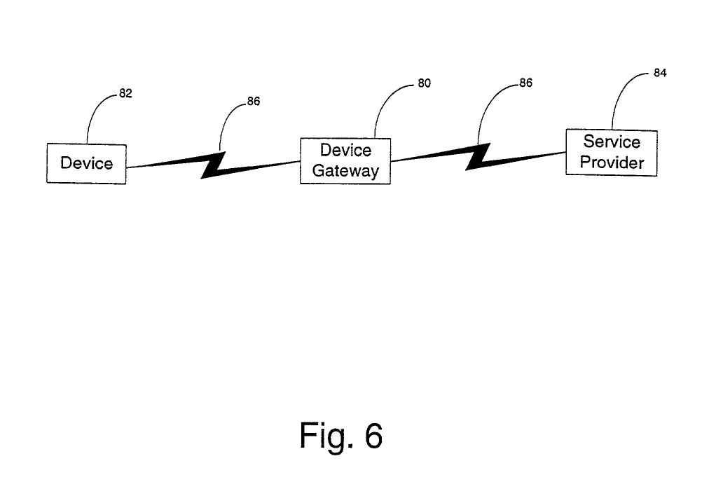

FIG. 6 shows a schematic of a gateway device 80 in operation with a device 82 located at a first site and a service provider 84 located at a second site. A site is any given physical locality such as a consumer's home, an office, a hospital, a laundromat, etc. In the illustrative embodiment of FIG. 6, the gateway device 80 can take the form of the gateway device shown in either FIG. 2 or FIG. 4. Both the device 82 and the service provider 84 are networked to the gateway device 80 over a communication path 86. The gateway device 80 may be located at the site of the device 82, at a site distinct from the device 82 and service provider 84 or at the service provider 84. If the gateway device 80 is located at the site of the device 82, then the device 82 can be networked to the gateway device 80 through a Local Area Network (LAN) and the service provider 84 can be networked through a WAN such as the Internet, intranet, extranet, etc. If the gateway device 80 is located at the site distinct from the device 82 and the service provider 84, then both the device and provider can be networked to the gateway device 80 through a WAN. If the gateway device 80 is located at the site of the service provider 84, then the device 82 can be networked to the gateway device 80 through a WAN and the service provider 84 can be networked through a LAN.

The device gateway of this application may perform several functions similar to those performed by a firewall, but differs from a firewall in at least two respects: transparency to devices and the nature of the networks being separated. Transparency to devices refers to how much impact the operation of the device gateway has on the operation of the devices it protects. A firewall is intended to segregate the network connecting computers and other equipment from some other, potentially “hostile” network. The computers and other equipment themselves operate identically whether the firewall is there or not. The device gateway, however, explicitly intends to act as a mediator between the devices it protects and the service provider(s). The devices “expect” a gateway to be present, and behave accordingly. (i.e. the device gateway does not “intercept” attempts by the devices to connect to providers, but instead the devices or providers explicitly communicate with the device gateway to request operations). Firewalls generally separate or partition off portions of general-purpose networks. That is, a firewall is used to separate the equipment connected to one general-purpose network from another general-purpose network. This partitioning is absolute: the network itself is partitioned and all devices on one side of the firewall are restricted from communicating with all devices on the other side of the firewall.

The device gateway, however, does not partition the network. It merely acts as a mediator for requests/operations made from either the devices which are connected on a particular network or with service provider(s) that communicate with the devices. Other devices connected to the same network as the protected devices may not use the device gateway to access other equipment on the network. For example, a given Ethernet network may have a set of network-aware devices including a TV, VCR, microwave, and a traditional home PC connected to it. The TV, VCR, and microwave would make use of a device gateway as a mediator for all communications to and from service providers; they might communicate with the gateway over the raw Ethernet protocol and not have TCP/IP addresses at all. The device gateway might translate the communications into TCP/IP in order to connect to a service provider located on the Internet, however. Meanwhile, the traditional home PC would not make use of the device gateway, since it does not seek to be “protected”. It can coexist on the same Ethernet network as the other devices and device gateway, yet not interfere with and not be affected by the other devices and the gateway. This differs from the behavior of a firewall, which would physically partition the Ethernet network from the outside network, affecting both the traditional PC and the gateway and devices. It should be noted that a compliant implementation of the device gateway might nonetheless act as a firewall under certain circumstances (e.g. if the network connecting the protected devices is a proprietary protocol on a separate network).

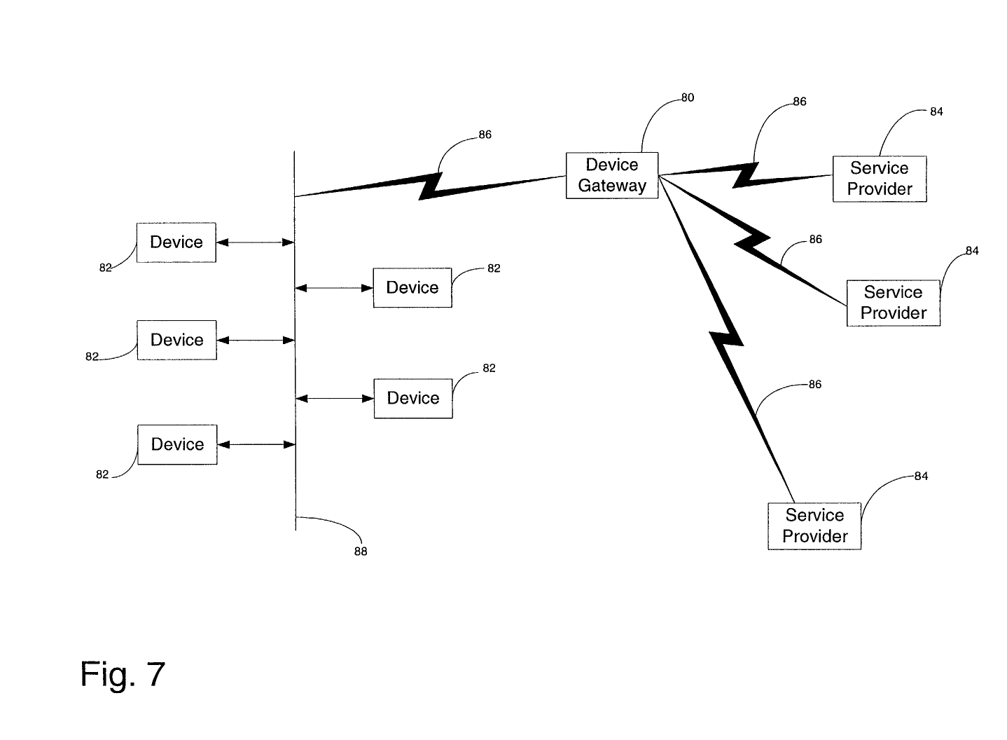

FIG. 7 shows a schematic of the gateway device 80 in operation with a plurality of devices 82 located at a first site and linked together in a network 90 with a plurality of service providers 84 located at a second site. The plurality of devices 82 can be networked together using existing network technology such as Ethernet, wireless, LAN, token ring, etc. and network protocols such as TCP/IP, UDP/IP, Ethernet, IPX/SPX or the like. Like FIG. 6, the gateway device 80 may be located at the site of the plurality of devices 82, at a site distinct from the devices 82 and plurality of service providers 84 or at the service providers 84. If the gateway device 80 is located at the site of the plurality of devices 82, then the devices 82 can be networked to the gateway device 80 through a LAN and the service providers 84 can be networked through a WAN such as the Internet, intranet, extranet, etc. via a firewall 88. If the gateway device 80 is located at the site distinct from the plurality of devices 82 and the plurality of service providers 84, then both the devices and providers can be networked to the gateway device 80 through a WAN.

The configurations shown in FIGS. 6-7 make the gateway device suitable for remote monitoring and diagnostics applications. For example, a hospital may have several medical imaging systems and may have an agreement with the manufacturer of the systems to provide service and support. The gateway device of this application would enable the manufacturer to perform remote monitoring and diagnostics activities on the medical imaging systems located at the hospital. In another example, a power plant may have several turbines in use that were manufactured by several different manufacturers and may have signed an agreement with a service organization, not necessarily associated with the manufacturers, to service and support the turbines. Placing a gateway device at the site of the plant would allow the site to control access to its turbines, restricting such access to the desired service organizations, while minimizing the number of resources (e.g. bandwidth, network addresses, etc.) required.

The configurations shown in FIGS. 6-7 also make the gateway device suitable for performing services on consumer products. For example, a consumer's home may have several appliances (e.g., dishwasher, air conditioner, refrigerator, oven, washing machine, etc.). The appliances could be the products of several manufacturers or may be from the same manufacturer. Placing the gateway device of this application at the consumer's home would enable specific manufacturers to monitor and upgrade their products in the home and would only permit a given manufacturer to access that manufacturer's product. The gateway device would enable the appliances to request information from another provider. For example, an air conditioner might query the local utility provider for the current cost of electricity so as to minimize the air conditioner's operating cost.

The foregoing flow charts of this disclosure show the architecture, functionality, and operation of a possible implementation of the gateway device for securely connecting arbitrary devices and service providers. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

The above-described gateway device for securely connecting arbitrary devices and service providers comprises an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

In the above-described embodiment of this application, the gateway device for securely connecting arbitrary devices and service providers can be implemented in C++ or JAVA, however, other languages such as C, Eiffel, ASP, LISP, etc. can be used.

As mentioned above, the device gateways for securely connecting arbitrary devices and service providers are not limited to a software implementation. For instance, the request handler, access authorizer, authenticator, activity manager, response component, network protocol translator and data format translator functions may take the form of hardware or firmware or combinations of software, hardware, and firmware.

It is apparent that there has been provided in accordance with this invention, a gateway device for securely connecting arbitrary devices and service providers. While the invention has been particularly shown and described in conjunction with a preferred embodiment thereof, it will be appreciated that variations and modifications can be effected by a person of ordinary skill in the art without departing from the scope of the invention.

What is claimed is:

1. A gateway device for securely managing activities between at least one device and at least one service provider, comprising:
an authenticator that authenticates the identity of the at least one service provider and the at least one device;
an access authorizer that permits the at least one service provider to interact with the at least one device; and
an activity manager, responsive to the access authorizer and the authenticator, that manages the activities occurring between the at least one service provider and the at least one device.

2. The gateway device according to claim 1, wherein the authenticator comprises a digital signature that uniquely identifies the gateway device to the at least one service provider and the at least one device.

3. The gateway device according to claim 1, wherein the authenticator comprises a digital signal verifier that verifies signatures associated with the at least one service provider and the at least one device.

4. The gateway device according to claim 1, wherein the authenticator comprises a cryptographic component that encrypts and decrypts activities between the at least one service provider and the at least one device.

5. The gateway device according to claim 1, wherein the access authorizer specifies permitted activities for the at least one service provider and the at least one device.

6. The gateway device according to claim 1, further comprising a request handler that receives activity requests from the at least one service provider and the at least one device.

7. The gateway device according to claim 1, further comprising a response component that receives activity responses from the at least one service provider and the at least one device.

8. The gateway device according to claim 1, further comprising a data format translator that translates the format of data transmitted and received by the at least one service provider and the at least one device.

9. The gateway device according to claim 1, further comprising a network protocol translator that translates a network protocol associated with the at least one service provider with a network protocol associated with the at least one device.

10. A gateway device for securely managing activities between a plurality of devices linked together in a first network and a plurality of service providers linked to the plurality of devices by a second network, comprising:
an authenticator that authenticates the identity of the plurality of devices and the plurality of service providers;
an access authorizer that permits the plurality of devices to interact with the plurality of service providers; and
an activity manager, responsive to the access authorizer and the authenticator, that manages the activities occurring between the plurality of devices and the plurality of service providers.

11. The gateway device according to claim 10, wherein the authenticator comprises a digital signature that uniquely identifies the gateway device to the plurality of devices and the plurality of service providers.

12. The gateway device according to claim 10, wherein the authenticator comprises a digital signal verifier that verifies signatures associated with the plurality of devices and the plurality of service providers.

13. The gateway device according to claim 10, wherein the authenticator comprises a cryptographic component that encrypts and decrypts activities between the plurality of devices and the plurality of service providers.

14. The gateway device according to claim 10, wherein the access authorizer specifies permitted activities for the plurality of devices and the plurality of service providers.

15. The gateway device according to claim 10, further comprising a request handler that receives activity requests from the plurality of devices and the plurality of service providers.

16. The gateway device according to claim 10, further comprising a response component that receives activity responses from the plurality of devices and the plurality of service providers.

17. The gateway device according to claim 10, further comprising a data format translator that translates the format of data transmitted and received by the plurality of devices and the plurality of service providers.

18. The gateway device according to claim 10, further comprising a network protocol translator that translates a network protocol associated with the plurality of devices in the first network and a network protocol associated with the plurality of service providers in the second network.

19. A gateway device for securely managing activities between at least one device and at least one service provider, comprising:
a request handler that receives activity requests from the at least one service provider and the at least one device;
an authenticator that authenticates the identity of the at least one service provider and the at least one device;
an access authorizer that permits the at least one service provider to interact with the at least one device;
an activity manager that manages the activity requests occurring between the at least one service provider and the at least one device; and
a response component, responsive to the request handler,the authenticator, the access authorizer, and the activity manager, that receives activity responses from the at least one service provider and the at least one device.

20. The gateway device according to claim 19, wherein the authenticator comprises a digital signature that uniquely identifies the gateway device to the at least one service provider and the at least one device.

21. The gateway device according to claim 19, wherein the authenticator comprises a digital signal verifier that verifies signatures associated with the at least one service provider and the at least one device.

22. The gateway device according to claim 19, wherein the authenticator comprises a cryptographic component that encrypts and decrypts activities between the at least one service provider and the at least one device.

23. The gateway device according to claim 19, wherein the access authorizer specifies permitted activities for the at least one service provider and the at least one device.

24. The gateway device according to claim 20, further comprising a data format translator that translates the format of data transmitted and received by the at least one service provider and the at least one device.

25. The gateway device according to claim 20, further comprising a network protocol translator that translates a network protocol associated with the at least one service provider with a network protocol associated with the at least one device.

26. A gateway device for securely managing activities between at least one device and at least one service provider, comprising:
a request handler that receives activity requests from the at least one service provider and the at least one device;
an authenticator that authenticates the identity of the at least one service provider and the at least one device;
an access authorizer that permits the at least one service provider to interact with the at least one device;
an activity manager that manages the activity requests occurring between the at least one service provider and the at least one device;
a data format translator that translates the format of data transmitted and received by the at least one service provider and the at least one device during the activities; and
a response component, responsive to the request handler, the authenticator, the access authorizer, the activity manager, and the data format translator, that receives activity responses from the at least one service provider and the at least one device.

27. A gateway device for securely managing activities between at least one device and at least one service provider, comprising:
means for authenticating the identity of the at least one service provider and the at least one device;
means for permitting the at least one service provider to interact with the at least one device; and
means, responsive to the permitting means and the authenticating means, for managing the activities occurring between the at least one service provider and the at least one device.

28. The gateway device according to claim 27, wherein the authenticating means comprises a digital signature that uniquely identifies the gateway device to the at least one service provider and the at least one device.

29. The gateway device according to claim 27, wherein the authenticating means comprises means for verifying signatures associated with the at least one service provider and the at least one device.

30. The gateway device according to claim 27, wherein the authenticating means comprises means for encrypting and decrypting activities between the at least one service provider and the at least one device.

31. The gateway device according to claim 27, wherein the permitting means specifies permitted activities for the at least one service provider and the at least one device.

32. The gateway device according to claim 27, further comprising means for receiving activity requests from the at least one service provider and the at least one device.

33. The gateway device according to claim 27, further comprising means for receiving activity responses from the at least one service provider and the at least one device.

34. The gateway device according to claim 27, further comprising means for translating the format of data transmitted and received by the at least one service provider and the at least one device.

35. The gateway device according to claim 27, further comprising means for translating a network protocol associated with the at least one service provider with a network protocol associated with the at least one device.

36. A system for securely providing services between a first site and a second site, comprising:
at least one appliance linked in a first network at the first site;
a service provider linked to the at least one appliance in a second network at the second site; and
a gateway device that securely manages the services provided between the at least one appliance and the service provider, the gateway device comprising an authenticator that authenticates the identity of the service provider and the at least one appliance; an access authorizer that permits the service provider to interact with the at least one appliance; and a service manager, responsive to the authenticator and the access authorizer, that manages the services provided between the service provider and the at least one appliance.

37. The system according to claim 36, wherein the authenticator comprises a digital signature that uniquely identifies the gateway device to the service provider and the at least one appliance.

38. The system according to claim 36, wherein the authenticator comprises a digital signal verifier that verifies signatures associated with the service provider and the at least one appliance.

39. The system according to claim 36, wherein the authenticator comprises a cryptographic component that encrypts and decrypts services provided between the service provider and the at least one appliance.

40. The system according to claim 36, wherein the access authorizer specifies permitted services for the service provider and the at least one appliance.

41. The system according to claim 36, further comprising a request handler that receives service requests from the service provider and the at least one appliance.

42. The system according to claim 36, further comprising a response component that receives service responses from the service provider and the at least one appliance.

43. The system according to claim 36, further comprising a data format translator that translates the format of data transmitted and received by the service provider and the at least one appliance.

44. The system according to claim 36, further comprising a network protocol translator that translates a network protocol associated with the service provider with a network protocol associated with the at least one appliance.

45. A system for securely providing remote monitoring and diagnostics, comprising:
at least one device linked in a first network;
a service provider linked to the at least one device in a second network; and
a gateway device that securely manages remote monitoring and diagnostic activities between the at least one device and the service provider, the gateway device comprising an authenticator that authenticates the identity of the service provider and the at least one device; an access authorizer that permits the service provider to interact with the at least one device; and an activity manager, responsive to the authenticator and access authorizer, that manages the remote monitoring and diagnostic activities provided between the service provider and the at least one device.

46. The system according to claim 45, wherein the authenticator comprises a digital signature that uniquely identifies the gateway device to the service provider and the at least one device.

47. The system according to claim 45, wherein the authenticator comprises a digital signal verifier that verifies signatures associated with the service provider and the at least one device.

48. The system according to claim 45, wherein the authenticator comprises a cryptographic component that encrypts and decrypts remote monitoring and diagnostic activities provided between the service provider and the at least one device.

49. The system according to claim 45, wherein the access authorizer specifies permitted remote monitoring and diagnostic activities for the service provider and the at least one device.

50. The system according to claim 45, further comprising a request handler that receives remote monitoring and diagnostic requests from the service provider and the at least one device.

51. The system according to claim 45, further comprising a response component that receives remote monitoring and diagnostic responses from the service provider and the at least one device.

52. The system according to claim 45, further comprising a data format translator that translates the format of data transmitted and received by the service provider and the at least one device.

53. The system according to claim 45, further comprising a network protocol translator that translates a network protocol associated with the service provider with a network protocol associated with the at least one device.

54. A method for securely managing activities between at least one device and at least one service provider, comprising:
authenticating the identity of the at least one service provider and the at least one device;
permitting the at least one service provider to interact with the at least one device; and
managing the activities occurring between the at least one service provider and the at least one device.

55. The method according to claim 54, wherein the authenticating comprises verifying signatures associated with the at least one service provider and the at least one device.

56. The method according to claim 54, wherein the authenticating comprises encrypting and decrypting activities between the at least one service provider and the at least one device.

57. The method according to claim 54, wherein the permitting comprises specifying permitted activities for the at least one service provider and the at least one device.

58. The method according to claim 54, further comprising receiving activity requests from the at least one service provider and the at least one device.

59. The method according to claim 54, further comprising receiving activity responses from the at least one service provider and the at least one device.

60. The method according to claim 54, further comprising translating the format of data transmitted and received by the at least one service provider and the at least one device.

61. The method according to claim 54, further comprising translating a network protocol associated with the at least one service provider with a network protocol associated with the at least one device.

62. A method for securely managing activities between a plurality of devices linked together in a first network and a plurality of service providers linked to the plurality of devices by a second network, comprising:
authenticating the identity of the plurality of devices and the plurality of service providers;
permitting the plurality of devices to interact with the plurality of service providers; and
managing the activities occurring between the plurality of devices and the plurality of service providers.

63. The method according to claim 62, wherein the authenticating comprises verifying signatures associated with the plurality of devices and the plurality of service providers.

64. The method according to claim 62, wherein the authenticating comprises encrypting and decrypting activities between the plurality of devices and the plurality of service providers.

65. The method according to claim 62, wherein the permitting comprises specifying permitted activities for the plurality of devices and the plurality of service providers.

66. The method according to claim 62, further comprising receiving activity requests from the plurality of devices and the plurality of service providers.

67. The method according to claim 62, further comprising receiving activity responses from the plurality of devices and the plurality of service providers.

68. The method according to claim 62, further comprising translating the format of data transmitted and received by the plurality of devices and the plurality of service providers.

69. The method according to claim 62, further comprising translating a network protocol associated with the plurality of devices in the first network and a network protocol associated with the plurality of service providers in the second network.

70. A method for securely managing activities between at least one device and at least one service provider, comprising:
receiving activity requests from the at least one service provider and the at least one device;
authenticating the identity of the at least one service provider and the at least one device;
permitting the at least one service provider to interact with the at least one device;
managing the activity requests occurring between the at least one service provider and the at least one device; and
receiving activity responses from the at least one service provider and the at least one device.

71. The method according to claim 70, wherein the authenticating comprises verifying signatures associated with the at least one service provider and the at least one device.

72. The method according to claim 70, wherein the authenticating comprises encrypting and decrypting activities between the at least one service provider and the at least one device.

73. The method according to claim 70, wherein the permitting comprises specifying permitted activities for the at least one service provider and the at least one device.

74. The method according to claim 70, further comprising translating the format of data transmitted and received by the at least one service provider and the at least one device.

75. The method according to claim 70, further comprising translating a network protocol associated with the at least one service provider with a network protocol associated with the at least one device.

76. A method for securely providing services between a first site and a second site, comprising:
providing at least one appliance linked in a first network at the first site;
providing a service provider linked to the at least one appliance in a second network at the second site; and
securely managing the services provided between the at least one appliance and the service provider, comprising authenticating the identity of the service provider and the at least one appliance; permitting the service provider to interact with the at least one appliance; and managing the services provided between the service provider and the at least one appliance.

77. The method according to claim 76, wherein the authenticating comprises verifying signatures associated with the service provider and the at least one appliance.

78. The method according to claim 76, wherein the authenticating comprises encrypting and decrypting services provided between the service provider and the at least one appliance.

79. The method according to claim 76, wherein the permitting comprises specifying permitted services for the service provider and the at least one appliance.

80. The method according to claim 76, further comprising receiving service requests from the service provider and the at least one appliance.

81. The method according to claim 76, further comprising receiving service responses from the service provider and the at least one appliance.

82. The method according to claim 76, further comprising translating the format of data transmitted and received by the service provider and the at least one appliance.

83. The method according to claim 76, further comprising translating a network protocol associated with the service provider with a network protocol associated with the at least one appliance.

84. A method for securely providing remote monitoring and diagnostics, comprising:
providing at least one device linked in a first network;
providing a service provider linked to the at least one device in a second network; and
securely managing remote monitoring and diagnostic activities between the at least one device and the service provider, comprising authenticating the identity of the service provider and the at least one device; permitting the service provider to interact with the at least one device; and managing the remote monitoring and diagnostic activities provided between the service provider and the at least one device.

85. The method according to claim 84, wherein the authenticating comprises verifying signatures associated with the service provider and the at least one device.

86. The method according to claim 84, wherein the authenticating comprises encrypting and decrypting remote monitoring and diagnostic activities provided between the service provider and the at least one device.

87. The method according to claim 84, wherein the permitting comprises specifying permitted remote monitoring and diagnostic activities for the service provider and the at least one device.

88. The method according to claim 84, further comprising receiving remote monitoring and diagnostic requests from the service provider and the at least one device

89. The method according to claim 84, further comprising receiving remote monitoring and diagnostic responses from the service provider and the at least one device.

90. The method according to claim 84, further comprising translating the format of data transmitted and received by the service provider and the at least one device.

91. The method according to claim 84, further comprising translating a network protocol associated with the service provider with a network protocol associated with the at least one device.

92. A computer-readable medium storing computer instructions for controlling a computer system to securely manage activities between at least one device and at least one service provider, the computer instructions comprising:
authenticating the identity of the at least one service provider and the at least one device;
permitting the at least one service provider to interact with the at least one device; and
managing the activities occurring between the at least one service provider and the at least one device.

93. The computer-readable medium according to claim 92, wherein the authenticating instructions comprises verifying signatures associated with the at least one service provider and the at least one device.

94. The computer-readable medium according to claim 92, wherein the authenticating instructions comprises encrypting and decrypting activities between the at least one service provider and the at least one device.

95. The computer-readable medium according to claim 92, wherein the permitting instructions comprises specifying permitted activities for the at least one service provider and the at least one device.

96. The computer-readable medium according to claim 92, further comprising receiving activity requests from the at least one service provider and the at least one device.

97. The computer-readable medium according to claim 92, further comprising receiving activity responses from the at least one service provider and the at least one device.

98. The computer-readable medium according to claim 92, further comprising translating the format of data transmitted and received by the at least one service provider and the at least one device.

99. The computer-readable medium according to claim 92, further comprising translating a network protocol associated with the at least one service provider with a network protocol associated with the at least one device.

100. A computer-readable medium storing computer instructions for controlling a computer system to securely manage activities between a plurality of devices linked together in a first network and a plurality of service providers linked to the plurality of devices by a second network, the computer instructions comprising:
authenticating the identity of the plurality of devices and the plurality of service providers;
permitting the plurality of devices to interact with the plurality of service providers; and
managing the activities occurring between the plurality of devices and the plurality of service providers.

101. A computer-readable medium storing computer instructions for controlling a computer system to securely manage activities between at least one device and at least one service provider, the computer instructions comprising:
receiving activity requests from the at least one service provider and the at least one device;
authenticating the identity of the at least one service provider and the at least one device;
permitting the at least one service provider to interact with the at least one device;
managing the activity requests occurring between the at least one service provider and the at least one device; and
receiving activity responses from the at least one service provider and the at least one device.
